(19) United States
(12) Patent Application Publication
(10) Pub. No.: US 2025/0301933 A1
(43) Pub. Date: Oct. 2, 2025

(54) SPRING ACTION SHOVEL

(71) Applicant: TITUS LOGAN, TRUMBULL, CT (US)

(72) Inventor: TITUS LOGAN, TRUMBULL, CT (US)

(21) Appl. No.: 18/616,324

(22) Filed: Mar. 26, 2024

(51) Int. Cl. A01B 1/02; B25G 1/01

(52) U.S. Cl. CPC A01B 1/02; B25G 1/01

(57) ABSTRACT

The spring action shovel includes a hand grip, a shaft, a shock absorbing mechanism, and a shovel blade. The spring action shovel may be a hand-operated tool for moving material. The spring action shovel may be adapted to be held by placing a first user hand on the shaft and a second user hand on the hand grip. The shock absorbing mechanism may be located within the shaft and may be configured to minimize injuries due to repetitive or impactful motions of the shovel blade. The shock absorbing mechanism may comprise a stiffness adjustment that may be adapted for a user to vary the compressive stiffness of the shock absorbing mechanism.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of tools, more specifically, a spring action shovel.

### SUMMARY OF INVENTION

The spring action shovel may comprise a hand grip, a shaft, a shock absorbing mechanism, and a shovel blade. The spring action shovel may be a hand-operated tool for moving material. The spring action shovel may be adapted to be held by placing a first user hand on the shaft and a second user hand on the hand grip. The shock absorbing mechanism may be located within the shaft and may be configured to minimize injuries due to repetitive or impactful motions of the shovel blade. The shock absorbing mechanism may comprise a stiffness adjustment that may be adapted for a user to vary the compressive stiffness of the shock absorbing mechanism.

An object of the invention is to provide a shovel for moving materials.

Another object of the invention is to provide a two-part handle comprising an outer shaft and an inner shaft that may telescopically move independently of each other to change the length of the shovel.

A further object of the invention is to provide a shock absorbing mechanism comprising a spring within the handle.

Yet another object of the invention is to provide a stiffness adjustment that is accessible to the user.

These together with additional objects, features and advantages of the spring action shovel will be readily apparent to those of ordinary skill in the art upon reading the following detailed description of the presently preferred, but nonetheless illustrative, embodiments when taken in conjunction with the accompanying drawings.

In this respect, before explaining the current embodiments of the spring action shovel in detail, it is to be understood that the spring action shovel is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the spring action shovel.

It is therefore important that the claims be regarded as including such equivalent construction insofar as they do not depart from the spirit and scope of the spring action shovel. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an isometric top front view of an embodiment of the disclosure.

FIG. 2 is an isometric bottom rear view of an embodiment of the disclosure.

FIG. 3 is a front view of an embodiment of the disclosure, illustrating the shovel when the spring is expanded.

FIG. 4 is a front view of an embodiment of the disclosure, illustrating the shovel when the spring is compressed.

FIG. 5 is an isometric detail view of an embodiment of the disclosure.

FIG. 6 is a cross-sectional view of an embodiment of the disclosure, illustrating the shovel when the spring is expanded.

FIG. 7 is a cross-sectional view of an embodiment of the disclosure, illustrating the shovel when the spring is compressed.

FIG. 8 is a cross-sectional view of an embodiment of the disclosure, illustrating use of the stiffness adjustment.

FIG. 9 is an exploded view of an embodiment of the disclosure, illustrating the stiffness adjustment.

FIG. 10 is an exploded view of an embodiment of the disclosure, illustrating the hand grip.

FIG. 11 is an exploded view of an embodiment of the disclosure, illustrating the shovel blade.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

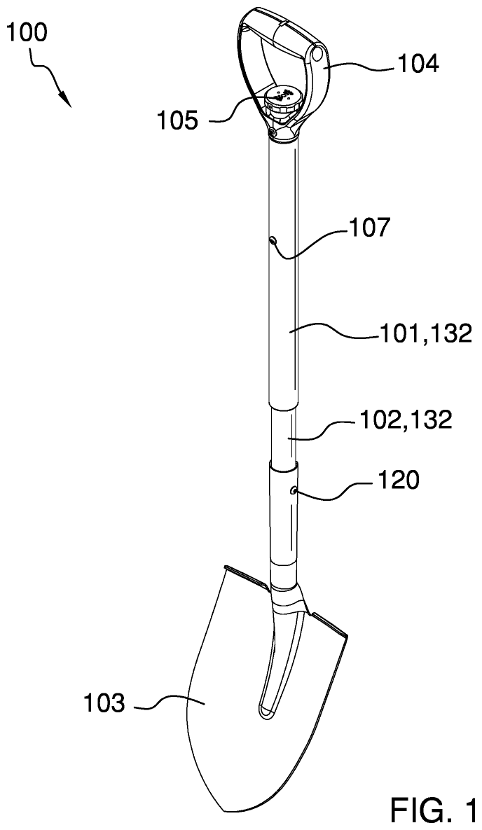

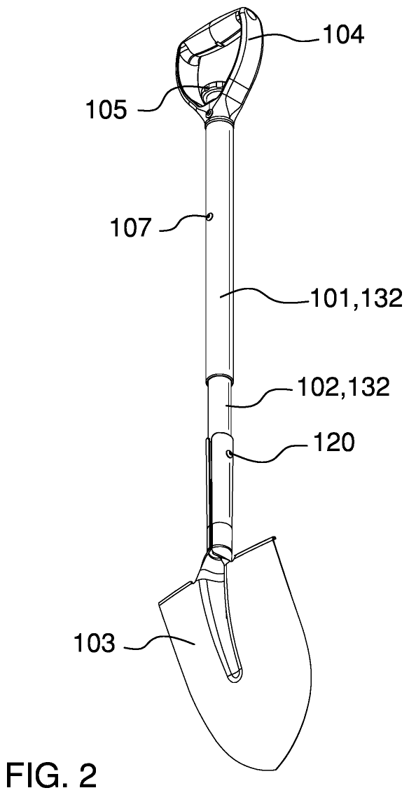

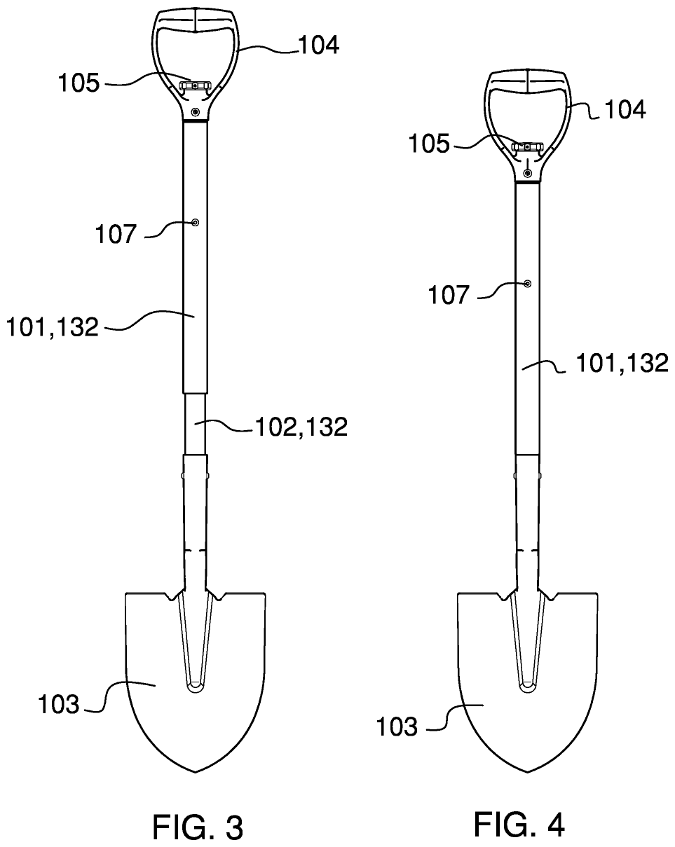

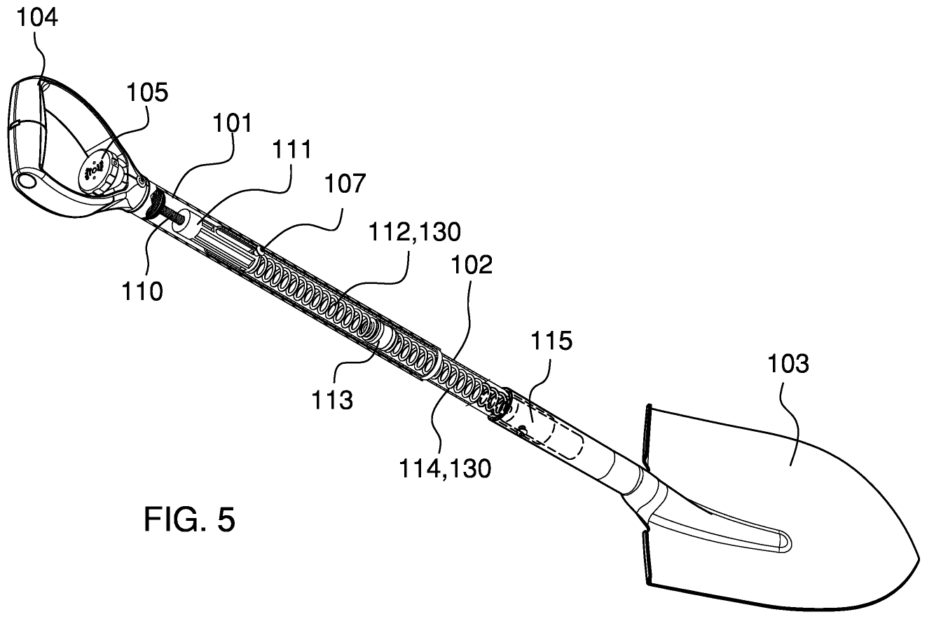

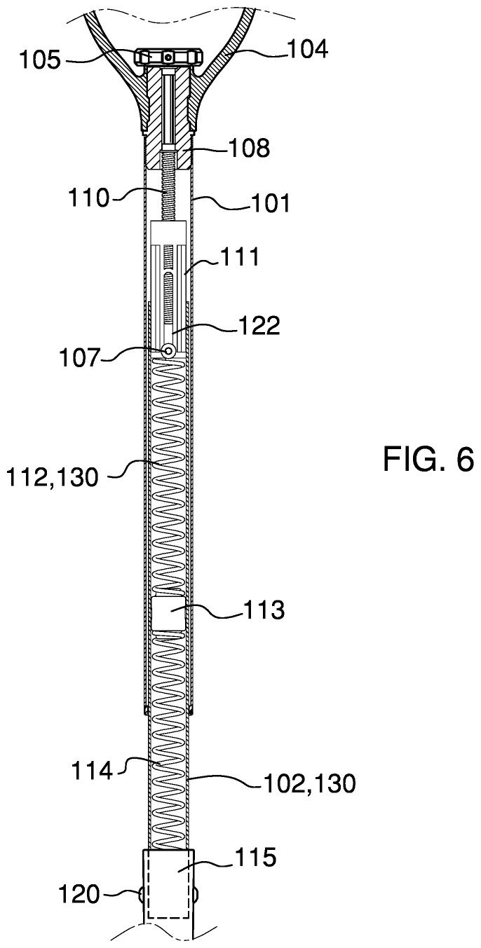

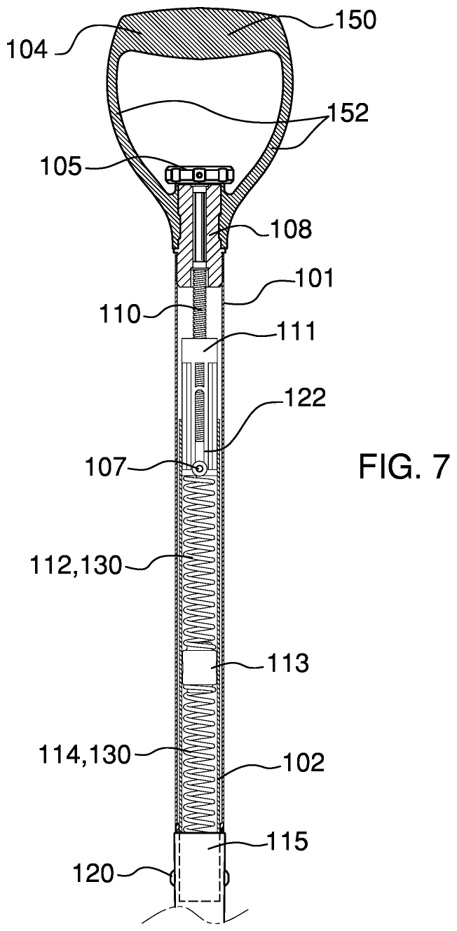

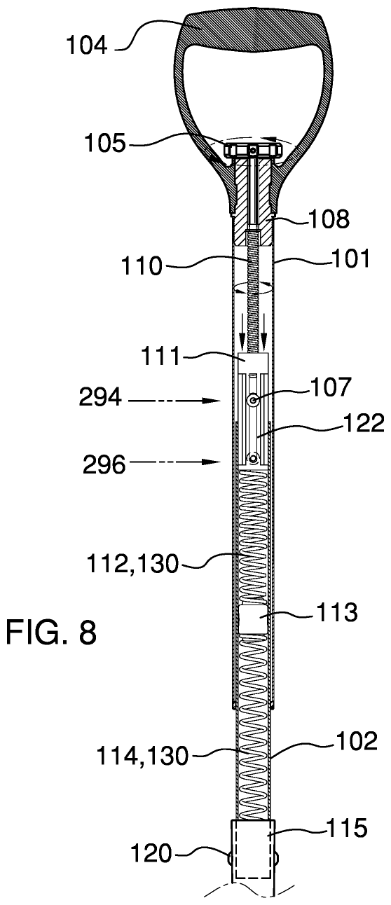

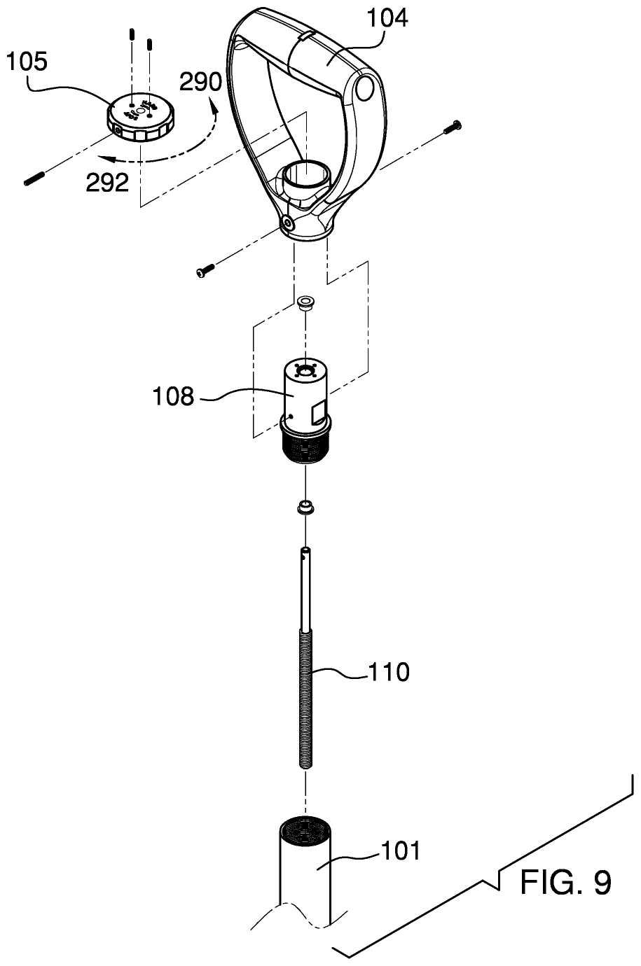

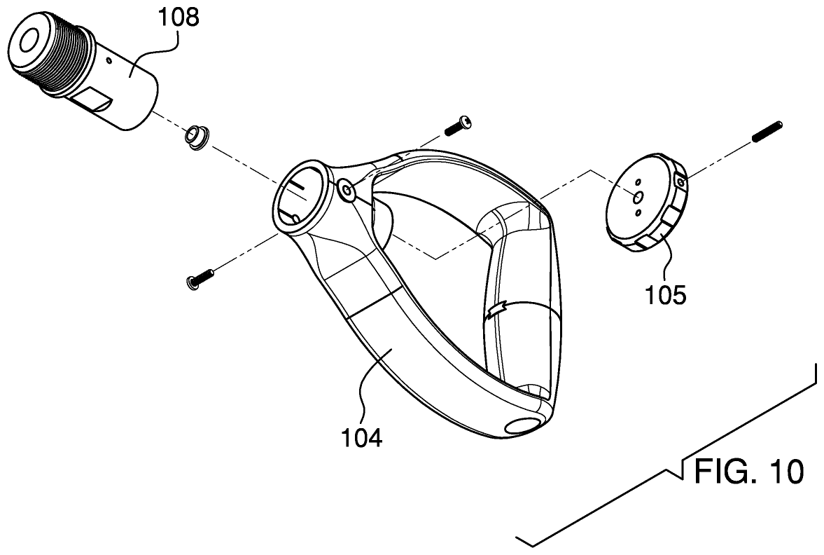

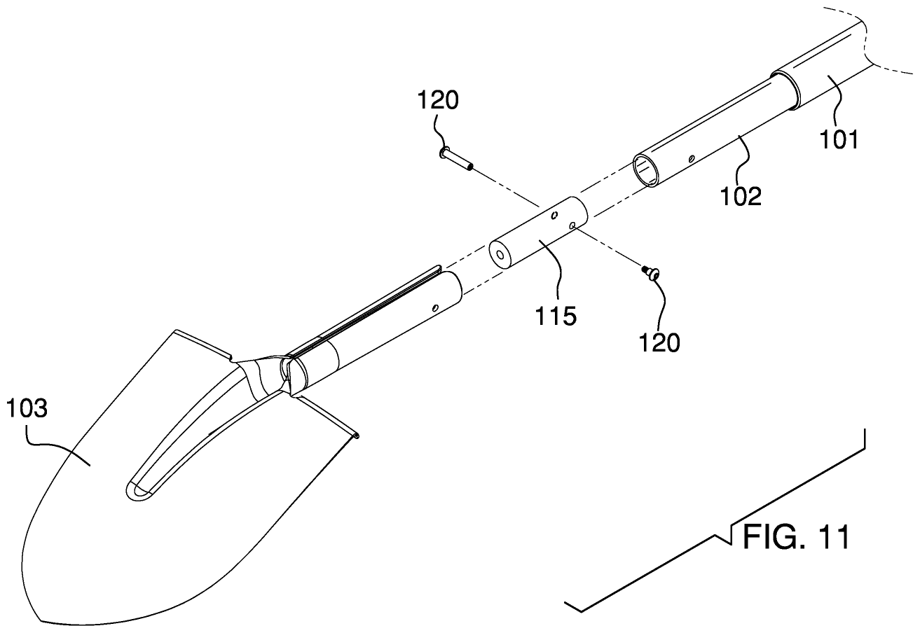

Detailed reference will now be made to a first potential embodiment of the disclosure, which is illustrated in FIGS. 1 through 11.

The spring action shovel 100 (hereinafter invention) comprises a hand grip 104, a shaft 132, a shock absorbing mechanism, and a shovel blade 103. The invention 100 may be a hand-operated tool for moving material. The invention 100 may be adapted to be held by placing a first user hand on the shaft 132 and a second user hand on the hand grip 104. The shock absorbing mechanism may be located within the shaft 132 and may be configured to minimize injuries due to repetitive or impactful motions of the shovel blade 103. The shock absorbing mechanism may comprise a stiffness adjustment that may be adapted for a user to vary the compressive stiffness of the shock absorbing mechanism.

The hand grip 104 may be adapted to be grasped by the user. The hand grip 104 may be a D-grip comprising a straight horizontal top portion 150 and a semi-circular or V-shaped lower portion 152. The hand grip 104 may be coupled to the upper end of the shaft 132.

The top of the shaft 132 may be coupled to the hand grip 104 and the bottom of the shaft 132 may be coupled to the shovel blade 103. The shaft 132 may comprise an outer shaft 101 at the top and an inner shaft 102 at the bottom. The inner shaft 102 may have a smaller diameter that the outer shaft 101 and may slide within the outer shaft 101. Thus, the length of the shaft 132 may vary.

The top end of the outer shaft 101 may be terminated by an upper plug 108. The bottom end of the inner shaft 102 may be terminated by a lower plug 115.

The outer shaft 101 may be a cylindrical tube comprising an upper cavity. The upper cavity may be a hollow central portion of the outer shaft 101. The top of the outer shaft 101 may be coupled to the bottom of the hand grip 104.

The inner shaft 102 may be a cylindrical tube comprising a lower cavity. The lower cavity may be a hollow central portion of the inner shaft 102. The bottom of the inner shaft 102 may be coupled to the shovel blade 103 using a shovel attachment screw 120.

The outside diameter of inner shaft may be less than the inside diameter of outer shaft such that the inner shaft 102 may slide into the upper cavity. When the outer shaft 101, the inner shaft 102, and a spring 130 are assembled, the outer shaft 101 may overlap the inner shaft 102 by a minimum of 5 inches. The upper cavity may provide space for the inner shaft 102 to slide further into the outer shaft 101 to accommodate compression of the spring 130. The upper cavity and the lower cavity may provide space to house the spring 130.

The shock absorbing mechanism may be a device that absorbs and dampens shock impulses. As a non-limiting example, if the shovel blade 103 encounters a rock while shoveling material and forward movement of the shovel blade 103 stops abruptly, the shock absorbing mechanism may absorb the shock impulse instead of passing the shock impulse to the user via the shaft 132.

The shock absorbing mechanism may comprise the spring 130 and the stiffness adjustment. The spring 130 may be housed within the shaft 132 where the spring 130 may be inaccessible to the user for safety reasons. The outside diameter of the spring may be less than the inside diameter of inside shaft so that the spring 130 may fit into the shaft 132. The upper end of the spring 130 may couple indirectly to the outer shaft 101 via the stiffness adjustment. The lower end of the spring 130 may couple to the inner shaft 102. The spring 130 may enable the inner shaft 102 to move relative to the outer shaft 101. The longitudinal axes of the outer shaft 101, the inner shaft 102, and the spring 130 may be aligned along the longitudinal axis of the shaft 132.

The spring 130 may be a helical compression spring. The spring 130 may comprise an upper spring 112, a lower spring 114, and a buffer bushing 113. The upper spring 112 may be located above the lower spring 114. The upper spring 112 may be coupled to the lower spring 114 at the buffer bushing 113. The top end of the upper spring 112 may be coupled to the bottom of a spring block 111.

The buffer busing 113 serves multiple purposes:
1 it acts as an inertial body to aid in impact reduction such that after impact it will also continue to move in a downward direction compressing the lower spring;
2 it acts as an impulse reducer at maximum compressed state, which prevents the tool from damage to the shovel (or user) by absorbing the impact load once the springs are fully compressed; and
3 it acts as a dampener to reduce ‘kickback’ or vibration by having a slight friction fit between the walls of the tube such that the buffer will attenuate the spring vibration.

The stiffness adjustment may be adapted for the user to grasp and turn in order to adjust compression of the spring 130. The stiffness adjustment comprises a spring adjustment knob 105, a spring adjustment rod 110, a guide screw 107, and the spring block 111. The spring adjustment knob 105 may be accessible within the fork of the hand grip 104. The spring adjustment knob 105 may be coupled to the top of the spring adjustment rod 110 such that turning the spring adjustment knob 105 rotates the spring adjustment rod 110. The bottom end of the spring adjustment rod 110 may be threaded and may threadedly couple to an aperture in the top center of the spring block 111. Rotation of the spring adjustment rod 110 may move the spring block 111 linearly within the shaft 132. The spring block 111 may move up within the shaft 132 when the spring adjustment knob 105 is turned in a first rotational direction 290 and the spring block 111 may move down within the shaft 132 when the spring adjustment knob 105 is turned in a second rotational direction 292, or vice versa. Because the top of the spring 130 is coupled to the spring block 111, turning the spring adjustment knob 105 may change the length, and therefore the amount of compression, of the spring 130.

Compressing the spring 130 may result in less travel distance for the outer shaft 101 and may establish a hard setting 294 for the invention 100. The hard setting 294 may make the invention 100 feel more rigid and therefore it may be easier for the user to feel shock impulses. Decompressing the spring 130 may result in more travel distance for the outer shaft 101 and may establish a soft setting 296 for the invention 100. The soft setting 296 may make the invention 100 feel less rigid and therefore it may absorb more of the shock impulses.

The guide screw 107 may be coupled to the outer shaft 101 and may pass laterally through the center of the outer shaft 101. The guide screw 107 may pass through an adjustment slot 122 in the spring block 111. The guide screw 107 may permit the spring block 111 to move linearly within the shaft 132 and may prevent the spring block 111 from rotating within the shaft 132.

In use, the invention 100 may be held by the user and used to move material. In general, the shovel blade 103 may be moved forward to a position under the material by pushing the hand grip 104 in the direction of the material. As the invention 100 is pushed forward, the shovel blade 103 may slide smoothly into the material less the shovel blade 103 strikes an obstacle. As a non-limiting example, the obstacle may be a large rock. The obstacle may abruptly stop forward motion of the shovel blade 103. Responsive to striking the obstacle, the spring 130 may compress to absorb the shock of the sudden stop instead of conveying the shock through the invention 100 to the user's hands, arms, and shoulders. Compression of the spring 130 may allow the outer shaft 101 and the hand grip 104 to stop moving gradually. As the spring 130 compresses, the outer shaft 101 may slide towards the inner shaft 102. Eventually, the spring 130 may rebound and push the outer shaft 101 back to its original position relative to the inner shaft 102.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used in this disclosure, an “aperture” may be an opening in a surface or object. Aperture may be synonymous with hole, slit, crack, gap, slot, or opening.

As used in this disclosure, a “cavity” may be an empty space or negative space that is formed within an object.

In this disclosure, “compress” may refer to forcing into a smaller space.

As used in this disclosure, a “compression spring” may be a wire coil that resists forces attempting to compress the wire coil in the direction of the center axis of the wire coil. The compression spring will return to its original position when the compressive force is removed.

As used herein, the words “couple”, “couples”, “coupled” or “coupling”, may refer to connecting, either directly or indirectly, and does not necessarily imply a mechanical connection.

As used in this disclosure, a “helix” may be the three dimensional structure that is formed by a wire that is wound uniformly around the surface of a cylinder or a cone. If the wire is wrapped around a cylinder the helix is called a cylindrical helix. If the wire is wrapped around a cone, the helix is called a conical helix. “Helical” may be an adjective which indicates that an object is shaped like a helix.

As used in this disclosure, “horizontal” may be a directional term that refers to a direction that is perpendicular to the local force of gravity. Unless specifically noted in this disclosure, the horizontal direction is always perpendicular to the vertical direction.

As used herein, “inside diameter” or “inner diameter” may refer to a measurement made on a hollow object. Specifically, the inside diameter is the distance from one inside wall to the opposite inside wall.

As used in this disclosure, the word “lateral” may refer to the sides of an object or movement towards a side. Lateral directions are generally perpendicular to longitudinal directions. “Laterally” may refer to movement in a lateral direction.

As used herein, the word “longitudinal” or “longitudinally” may refer to a lengthwise or longest direction or to a direction that is perpendicular to the lateral direction.

As used herein, “outside diameter” or “outer diameter” may refer to a measurement made on an object. Specifically, the outside diameter is the distance from one point on the outside of the object to a point on the opposite side of the object along a line passing through the center of the object.

As used in this disclosure, the term “shaft” may be used to describe a rigid cylinder. A shaft is often used as the handle of a tool or implement or as the center of rotating machinery or motors. The definition of shaft explicitly includes solid shafts or shafts that comprise a hollow passage through the shaft along the center axis of the shaft cylinder, whether the shaft has one or more sealed ends or not.

As used in this disclosure, a “shovel” may be a tool that is used for lifting and moving bulk items such as dirt, snow, or gravel. A shovel can be a hand tool or a mechanical device.

As used in this disclosure, a “slot” may be a prism-shaped negative space formed as a groove, cut, opening, or aperture in or through an object.

As used in this disclosure, a “spring” may be a device that is used to store mechanical energy. This mechanical energy will often be stored by deforming an elastomeric material that is used to make the device, by the application of a torque to a rigid structure, or by a combination thereof. In some embodiments, the rigid structure to which torque is applied may be composed of metal or plastic.

As used herein, “travel” or “travel distance” may refer to the maximum distance that a mechanical part may move due to constraints imposed by the system. As a non-limiting example, the travel distance of a component may be constrained by interference with one or more other components such as mechanical stops.

With respect to the above description, it is to be realized that the optimum dimensional relationship for the various components of the invention described above and in FIGS. 1 through 11, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A spring action shovel comprising:
a hand grip, a shaft, a shock absorbing mechanism, and a shovel blade;
wherein the spring action shovel is a hand-operated tool for moving material;
wherein the spring action shovel is adapted to be held by placing a first user hand on the shaft and a second user hand on the hand grip;
wherein the shock absorbing mechanism is located within the shaft and is configured to minimize injuries due to repetitive or impactful motions of the shovel blade;
wherein the shock absorbing mechanism comprises a stiffness adjustment that is adapted for a user to vary the compressive stiffness of the shock absorbing mechanism.

2. The spring action shovel according to claim 1
wherein the hand grip is adapted to be grasped by the user;
wherein the hand grip is a D-grip comprising a straight horizontal top portion and a semi-circular or V-shaped lower portion;
wherein the hand grip is coupled to the upper end of the shaft.

3. The spring action shovel according to claim 2
wherein the top of the shaft is coupled to the hand grip and the bottom of the shaft is coupled to the shovel blade;
wherein the shaft comprises an outer shaft at the top and an inner shaft at the bottom.

4. The spring action shovel according to claim 3
wherein the inner shaft has a smaller diameter that the outer shaft and slides within the outer shaft;
wherein the length of the shaft is variable.

5. The spring action shovel according to claim 4
wherein the top end of the outer shaft is terminated by an upper plug;
wherein the bottom end of the inner shaft is terminated by a lower plug.

6. The spring action shovel according to claim 5
wherein the outer shaft is a cylindrical tube comprising an upper cavity;
wherein the upper cavity is a hollow central portion of the outer shaft;
wherein the top of the outer shaft is coupled to the bottom of the hand grip.

7. The spring action shovel according to claim 6
wherein the inner shaft is a cylindrical tube comprising a lower cavity;
wherein the lower cavity is a hollow central portion of the inner shaft;
wherein the bottom of the inner shaft is coupled to the shovel blade using a shovel attachment screw.

8. The spring action shovel according to claim 7
wherein the outside diameter of inner shaft is less than the inside diameter of outer shaft such that the inner shaft slides into the upper cavity;
wherein the upper cavity provides space for the inner shaft to slide further into the outer shaft to accommodate compression of a spring;
wherein the upper cavity and the lower cavity provide space to house the spring.

9. The spring action shovel according to claim 8
wherein when the outer shaft, the inner shaft, and the spring are assembled, the outer shaft overlaps the inner shaft by a minimum of 5 inches.

10. The spring action shovel according to claim 8
wherein the shock absorbing mechanism is a device that absorbs and dampens shock impulses;
wherein the shock absorbing mechanism comprises the spring and the stiffness adjustment;
wherein the spring is housed within the shaft where the spring is inaccessible for safety reasons.

11. The spring action shovel according to claim 10
wherein the outside diameter of the spring is less than the inside diameter of inside shaft so that the spring fits into the shaft.

12. The spring action shovel according to claim 11
wherein the upper end of the spring couples indirectly to the outer shaft via the stiffness adjustment.

13. The spring action shovel according to claim 12
wherein the lower end of the spring couples to the inner shaft.

14. The spring action shovel according to claim 13
wherein the spring enables the inner shaft to move relative to the outer shaft;
wherein the longitudinal axes of the outer shaft, the inner shaft, and the spring are aligned along the longitudinal axis of the shaft.

15. The spring action shovel according to claim 14
wherein the spring is a helical compression spring;
wherein the spring comprises an upper spring, a lower spring, and a buffer bushing;
wherein the upper spring is located above the lower spring;
wherein the upper spring is coupled to the lower spring at the buffer bushing;
wherein the top end of the upper spring is coupled to the bottom of a spring block.

16. The spring action shovel according to claim 15
wherein the stiffness adjustment is adapted for the user to grasp and turn in order to adjust compression of the spring;
wherein the stiffness adjustment comprises a spring adjustment knob, a spring adjustment rod, a guide screw, and the spring block;
wherein the spring adjustment knob is accessible within the fork of the hand grip;
wherein the spring adjustment knob is coupled to the top of the spring adjustment rod such that turning the spring adjustment knob rotates the spring adjustment rod.

17. The spring action shovel according to claim 16
wherein the bottom end of the spring adjustment rod is threaded and threadedly couples to an aperture in the top center of the spring block;
wherein rotation of the spring adjustment rod moves the spring block linearly within the shaft;
wherein the spring block moves up within the shaft when the spring adjustment knob is turned in a first rotational direction and the spring block moves down within the shaft when the spring adjustment knob is turned in a second rotational direction, or vice versa;
wherein turning the spring adjustment knob changes the length, and therefore the amount of compression, of the spring.

18. The spring action shovel according to claim 17
wherein compressing the spring results in less travel distance for the outer shaft and establishes a hard setting for the spring action shovel.

19. The spring action shovel according to claim 18
wherein decompressing the spring results in more travel distance for the outer shaft and establishes a soft setting for the spring action shovel.

20. The spring action shovel according to claim 19
wherein the guide screw is coupled to the outer shaft and passes laterally through the center of the outer shaft;
wherein the guide screw passes through an adjustment slot in the spring block;
wherein the guide screw permits the spring block to move linearly within the shaft and prevents the spring block from rotating within the shaft.
